(19) United States
(12) Patent Application Publication
(10) Pub. No.: US 2016/0283829 A1
(43) Pub. Date: Sep. 29, 2016

(54) PRINT CONTROL APPARATUS, PRINTER, PRINT CONTROL METHOD, AND NON-TRANSITORY COMPUTER READABLE MEDIUM

(71) Applicant: FUJI XEROX CO., LTD., Tokyo (JP)

(72) Inventors: Keiji ISHIGURO, Kanagawa (JP); Atsuo MATSUNAGA, Kanagawa (JP); Masayuki KUDO, Kanagawa (JP); Masashi MURAKAMI, Kanagawa (JP); Kazuhide KOBAYASHI, Kanagawa (JP); Takayuki MATSUI, Kanagawa (JP)

(73) Assignee: FUJI XEROX CO., LTD., Tokyo (JP)

(21) Appl. No.: 14/810,561

(22) Filed: Jul. 28, 2015

(30) Foreign Application Priority Data
Mar. 26, 2015 (JP) 2015-065218

(51) Int. Cl. G06K 15/02

(52) U.S. Cl. CPC G06K 15/186; G06K 15/1849; G06K 15/1836; G06K 15/1823

(57) ABSTRACT

A print control apparatus includes a generating section, a converting section, a calculating section, and a selecting section. The generating section generates intermediate data by analyzing print data, the intermediate data being data in a stage preceding raster data that is a group of pixels. The converting section converts the intermediate data generated by the generating section into the raster data. The calculating section calculates an expected processing time, the expected processing time being an expected time to be spent on converting a predetermined amount of intermediate data generated by the generating section into raster data. The selecting section selects, as a printing speed of a print mechanism unit, any one of plural predetermined speeds by using the expected processing time calculated by the calculating section.

### CROSS-REFERENCE TO RELATED APPLICATIONS

This application is based on and claims priority under 35 USC 119 from Japanese Patent Application No. 2015-065218 filed Mar. 26, 2015.

### BACKGROUND

### Technical Field

The present invention relates to a print control apparatus, a printer, a print control method, and a non-transitory computer readable medium.

### SUMMARY

According to an aspect of the invention, there is provided a print control apparatus including a generating section, a converting section, a calculating section, and a selecting section. The generating section generates intermediate data by analyzing print data, the intermediate data being data in a stage preceding raster data that is a group of pixels. The converting section converts the intermediate data generated by the generating section into the raster data. The calculating section calculates an expected processing time, the expected processing time being an expected time to be spent on converting a predetermined amount of intermediate data generated by the generating section into raster data. The selecting section selects, as a printing speed of a print mechanism unit, any one of plural predetermined speeds by using the expected processing time calculated by the calculating section.

### BRIEF DESCRIPTION OF THE DRAWINGS

Exemplary embodiments of the present invention will be described in detail based on the following figures, wherein:

FIG. 1 is a diagram illustrating an example of the overall configuration of an image forming system according to a first exemplary embodiment of the present invention;

FIG. 2 is a diagram illustrating an example of the schematic configuration of an image forming apparatus according to the first exemplary embodiment;

FIG. 3 is a block diagram illustrating an example of the functional configuration of a controller included in the image forming apparatus according to the first exemplary embodiment;

FIGS. 4A and 4B are diagrams illustrating an example of performance evaluation information according to the first exemplary embodiment;

FIG. 5 is a flowchart illustrating an example of a processing procedure in which the image forming apparatus according to the first exemplary embodiment selects a printing speed and performs printing;

FIG. 6 is a block diagram illustrating an example of the functional configuration of a controller included in an image forming apparatus according to a second exemplary embodiment;

FIG. 7 is a flowchart illustrating an example of a processing procedure in which the image forming apparatus according to the second exemplary embodiment selects a printing speed and performs printing;

FIG. 8 is a flowchart illustrating an example of a processing procedure in which an image forming apparatus according to a third exemplary embodiment selects a printing speed and performs printing;

FIG. 9 is a flowchart illustrating an example of a processing procedure in which an image forming apparatus according to a fourth exemplary embodiment selects a printing speed and performs printing;

FIG. 10 is a block diagram illustrating an example of the functional configuration of controllers according to a fifth exemplary embodiment; and

FIG. 11 is a flowchart illustrating an example of a processing procedure in which an image forming apparatus according to the fifth exemplary embodiment selects a printing speed and performs printing.

### DETAILED DESCRIPTION

Hereinafter, exemplary embodiments of the present invention will be described in detail with reference to the attached drawings.

### First Exemplary Embodiment

### System Configuration

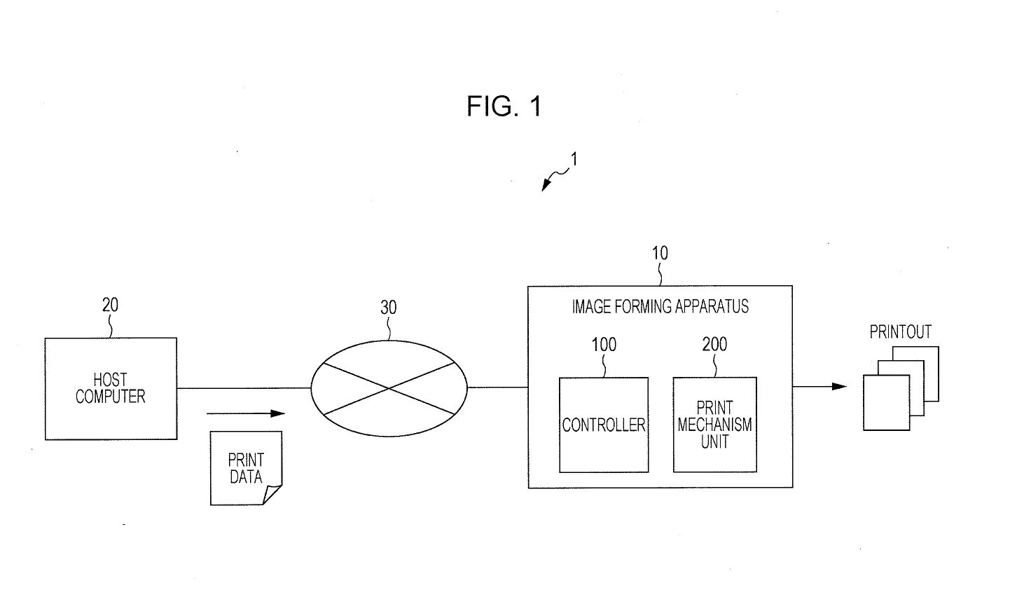

First, the overall configuration of an image forming system 1 according to a first exemplary embodiment will be described. FIG. 1 is a diagram illustrating an example of the overall configuration of the image forming system 1 according to the first exemplary embodiment. As illustrated in FIG. 1, the image forming system 1 includes an image forming apparatus 10 that has a function of forming an image and a host computer 20 that instructs the image forming apparatus 10 to form an image. The image forming apparatus 10 and the host computer 20 are connected to each other via a network 30. In this exemplary embodiment, the image forming apparatus 10 is used as an example of a printer.

The image forming apparatus 10 is, for example, an apparatus that has a print function, a scan function, a copy function, a facsimile function, and so forth. Here, the image forming apparatus 10 forms an image on continuous paper, which is an example of a recording material and is a band-shaped medium, so as to perform print processing. To perform print processing, the image forming apparatus 10 receives print data from the host computer 20 via the network 30. The image forming apparatus 10 then performs print processing by using the received print data. The print data includes image data as a target to be printed and a control instruction in which a setting for the print processing is described. The print data also includes information representing the length of continuous paper that is to be used for printing one page (hereinafter referred to as a unit page length).

The image forming apparatus 10 includes a print mechanism unit 200 that performs print processing (image formation) on continuous paper and a controller 100 that controls the print mechanism unit 200. In this exemplary embodiment, the controller 100 is used as an example of a print control apparatus. The print mechanism unit 200 is used as an example of a printing section.

The host computer 20 is a computer apparatus that is used to instruct the image forming apparatus 10 to form an image. For example, in response to a user operation, the host computer 20 generates print data for a document to be printed, transmits the generated print data to the image forming apparatus 10 via the network 30, and provides an instruction to form an image. Examples of the host computer 20 include a desktop personal computer (PC), a notebook PC, and a mobile information terminal (a so-called smartphone or tablet terminal).

The network 30 is a communication medium that is used for information communication between the image forming apparatus 10 and the host computer 20, and is, for example, a local area network (LAN).

### Schematic Configuration of Image Forming Apparatus 10

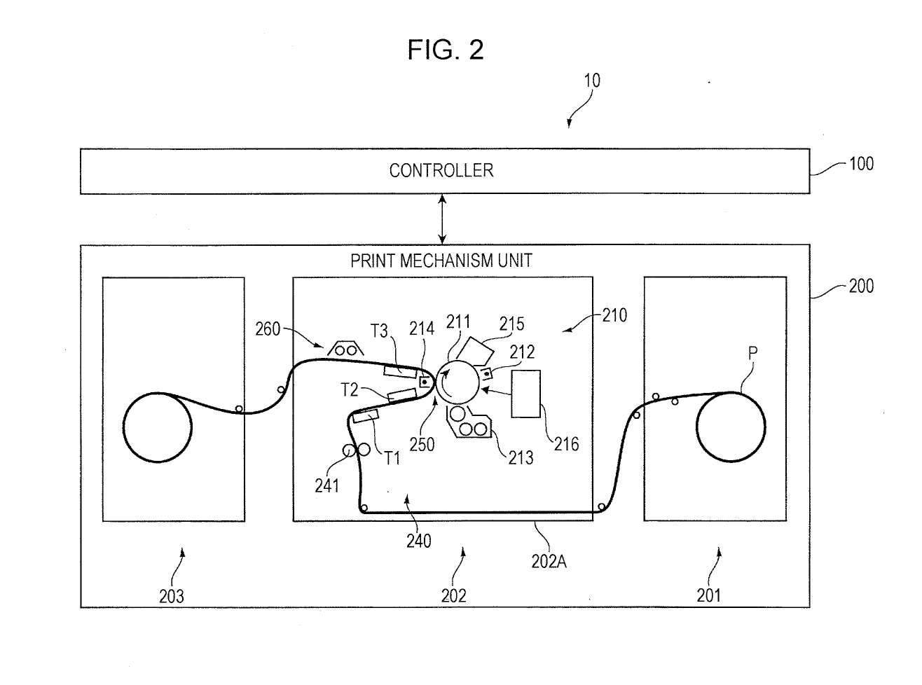

Next, the schematic configuration of the image forming apparatus 10 will be described. FIG. 2 is a diagram illustrating an example of the schematic configuration of the image forming apparatus 10.

The controller 100 includes a central processing unit (CPU), a read only memory (ROM), and a random access memory (RAM), which are not illustrated. The ROM stores a control program that is executed by the CPU. The CPU reads the control program stored in the ROM and executes the control program by using the RAM as a working area. With the control program being executed by the CPU, individual functions of the controller 100 are implemented. The controller 100 includes an operation panel, such as a touch panel, which displays various pieces of information and accepts input of a user operation.

The control program executed by the controller 100 may be provided by being stored in the ROM in advance and may be loaded into the RAM. Alternatively, in a case where the ROM is a rewritable memory, such as an electrically erasable programmable read-only memory (EEPROM), the control program may be installed into the ROM and loaded into the RAM after the CPU has been set. Alternatively, the control program may be provided by being stored in a computer readable recording medium, such as a magnetic recording medium (magnetic tape, magnetic disk, or the like), an optical recording medium (optical disc or the like), a magneto-optical recording medium, or a semiconductor memory. The control program may be downloaded into the controller 100 by using a communication medium, such as the Internet.

The print mechanism unit 200 includes a paper feeder 201 that feeds continuous paper P, a printing unit 202 that performs printing on the continuous paper P fed by the paper feeder 201, and a rewinder 203 that rewinds the continuous paper P that has passed through the printing unit 202. In the print mechanism unit 200, both the continuous paper P that has feed holes (sprocket holes) and the continuous paper P that does not have feed holes may be used.

The printing unit 202 includes an image forming unit 210 that performs image formation in accordance with input print data. The printing unit 202 also includes a paper transport unit 240 that functions as a transport section for transporting the continuous paper P transported thereto via the image forming unit 210. The printing unit 202 further includes a fixing device 260 that includes a flash lamp or the like and fixes a toner image formed on the continuous paper P.

The image forming unit 210 includes a photoconductor drum 211 on which a static latent image is formed during its rotation in the direction indicated by an arrow in FIG. 2, a charging device 212 for charging the surface of the photoconductor drum 211, a developing device 213 for developing the static latent image formed on the photoconductor drum 211 by using toner, and a transfer device 214 for transferring the toner image formed on the photoconductor drum 211 onto the continuous paper P. In this exemplary embodiment, a portion where the photoconductor drum 211 and the transfer device 214 face each other serves as a transfer unit 250. The toner image on the photoconductor drum 211 is transferred onto the continuous paper P in the transfer unit 250.

The image forming unit 210 further includes a drum cleaner 215 for cleaning the surface of the photoconductor drum 211 after a transfer operation, and a laser exposure device 216 for exposing the photoconductor drum 211. The laser exposure device 216 scans and exposes the photoconductor drum 211 with laser light, on/off of which is controlled based on obtained image data.

The paper transport unit 240 includes a back tension roller 241 that is provided so as to be able to reverse and transports the continuous paper P to the image forming unit 210. An aligning roller (not illustrated) is also provided downstream of the back tension roller 241. Also, a guide wall (not illustrated) is provided on a front side of a device body 202A along a transport direction of the continuous paper P. The guide wall guides the continuous paper P. In a case where the continuous paper P that is pinless is to be transported, the aligning roller positions the continuous paper P by placing it against the guide wall.

The paper transport unit 240 includes a first tractor T1, a second tractor T2, and a third tractor T3 that are located downstream of the back tension roller 241 in the transport direction of the continuous paper P. The first tractor T1 and the second tractor T2 transport the continuous paper P with pins to the transfer unit 250. The third tractor T3 transports the continuous paper P with pins that has passed through the transfer unit 250 toward the fixing device 260.

In the print mechanism unit 200, the continuous paper P is first supplied from the paper feeder 201 to the printing unit 202. The continuous paper P is transported to the transfer unit 250 by the back tension roller 241, the first tractor T1, and the second tractor T2. On the other hand, in the printing unit 202, image data is supplied to the laser exposure device 216. The surface of the photoconductor drum 211 charged by the charging device 212 is scanned and exposed with laser light, on/off of which is controlled by the laser exposure device 216, so that a static latent image is formed on the photoconductor drum 211.

The formed static latent image is developed by the developing device 213, and thereby a toner image is formed on the photoconductor drum 211. The toner image is transferred onto the continuous paper P by the transfer device 214. After that, the continuous paper P onto which the toner image has been transferred is transported to the fixing device 260. The toner image on the continuous paper P is subjected to a fixing process with heat performed by the fixing device 260, and is thereby fixed onto the continuous paper P. After that, the continuous paper P is ejected from the printing unit 202 and is rewound by the rewinder 203.

The print mechanism unit 200 performs print processing at the same paper feeding speed to prevent the occurrence of misregistration and maintain print quality. In this exemplary embodiment, a printing speed of the print mechanism unit 200 is selectable from among plural predetermined speeds, for example, three speeds Tₘₐₓ, T_{mid}, and Tₘᵢₙ. If print processing is performed at the highest speed Tₘₐₓ among the three speeds, the print processing is effectively performed at the highest speed. However, in a case where the controller 100 is incapable of preparing raster data that is received by the print mechanism unit 200 in accordance with the speed at which the print mechanism unit 200 performs print processing, the print mechanism unit 200 shifts to a stop state. Here, raster data is image data as a group of pixels, which represents an image as a series of colored dots.

In a case where the print mechanism unit 200 shifts to the stop state, print processing is restarted when raster data is prepared for the print mechanism unit 200. However, in a case where the print mechanism unit 200 shifts to the stop state, the processing time becomes longer than in the case of continuing printing at the same speed without a stop, that is, overhead including a processing time for shifting to the stop state and a processing time for restarting printing is produced in addition to the time for preparing raster data. Further, repetition of stopping and restarting may impose load on the image forming unit 210 and the paper transport unit 240 of the printing unit 202, which affects the life of the print mechanism unit 200. Accordingly, this exemplary embodiment addresses the above-described issues.

### Functional Configuration of Image Forming Apparatus

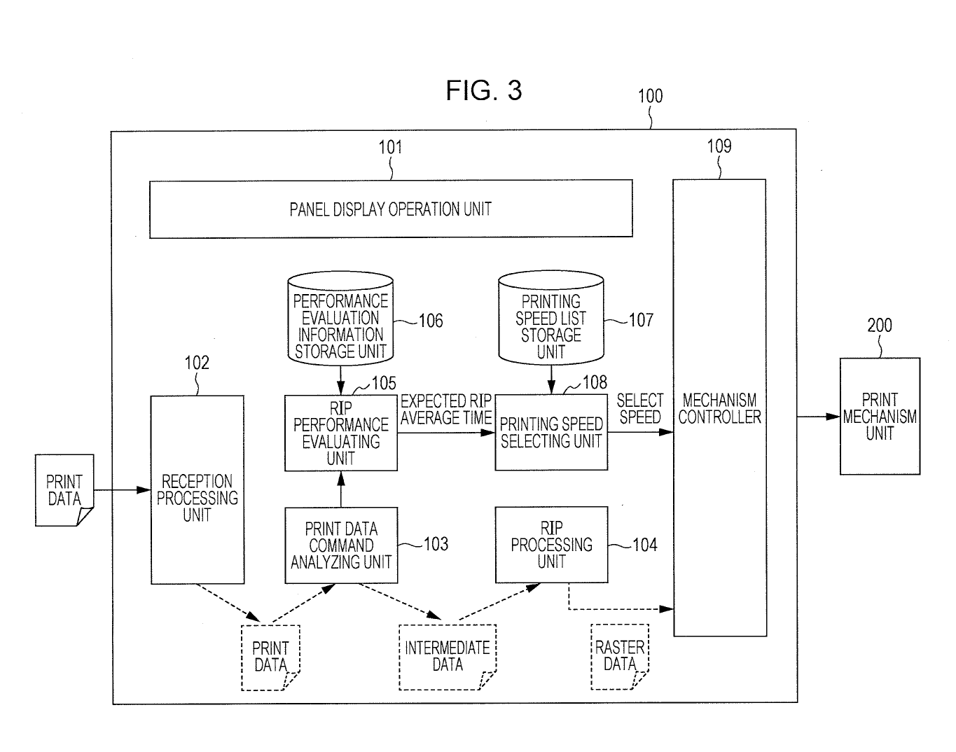

Hereinafter, the functional configuration of the controller 100 included in the image forming apparatus 10 will be described. FIG. 3 is a block diagram illustrating an example of the functional configuration of the controller 100 included in the image forming apparatus 10.

As illustrated in FIG. 3, the controller 100 includes a panel display operation unit 101 that displays various pieces of information and accepts input of a user operation, a reception processing unit 102 that receives print data, a print data command analyzing unit 103 that analyzes print data and generates data in an intermediate format (hereinafter referred to as intermediate data), a raster image processor (RIP) processing unit 104 that performs RIP processing on intermediate data to generate raster data, and a RIP performance evaluating unit 105 that calculates an expected time to be spent on RIP processing.

Also, the controller 100 includes a performance evaluation information storage unit 106 that stores a reference value for evaluating an expected time to be spent on RIP processing (hereinafter referred to as performance evaluation information), a printing speed list storage unit 107 that stores a list of printing speeds adoptable for printing (hereafter referred to as a printing speed list), a printing speed selecting unit 108 that selects any one of the printing speeds registered in the printing speed list, and a mechanism controller 109 that sequentially outputs pieces of raster data to the print mechanism unit 200 and outputs a control instruction for setting the printing speed selected by the printing speed selecting unit 108 to the print mechanism unit 200.

The panel display operation unit 101 displays various pieces of information about the image forming apparatus 10 on its screen, and also accepts input of a user operation on the screen.

The reception processing unit 102 receives print data transmitted from the host computer 20. Upon reception of the print data, the reception processing unit 102 stores the received print data in a print data memory.

The print data command analyzing unit 103, which is an example of a generating section, analyzes the print data stored in the print data memory by the reception processing unit 102 and generates intermediate data. After generating the intermediate data, the print data command analyzing unit 103 stores the generated intermediate data in an intermediate data memory. In general, image data included in print data is described in a page description language (PDL), such as PostScript (PS) or Portable Document Format (PDF). Image data described in such a PDL is represented by a figure of a complicated shape in some cases, and typically the image data is converted into data of a figure of a basic shape (primitive figure) as preprocessing of printing. The data generated through conversion into the primitive figure is intermediate data. The intermediate data is data in a stage preceding raster data.

The RIP processing unit 104, which is an example of a converting section, performs RIP processing on the intermediate data stored in the intermediate data memory by the print data command analyzing unit 103, so as to convert the intermediate data into raster data. Also, the RIP processing unit 104 stores the raster data generated through the conversion in a raster data memory, and sequentially outputs the raster data to the mechanism controller 109. Here, RIP processing is processing for converting intermediate data into raster data to output the data in the form of an image.

The RIP performance evaluating unit 105, which is an example of a calculating section, calculates, for each page, an expected time to be spent on RIP processing on the intermediate data stored in the intermediate data memory by the print data command analyzing unit 103, and calculates an average of the expected times calculated for the individual pages. Specifically, the RIP performance evaluating unit 105 calculates an expected time to be spent on RIP processing on intermediate data corresponding to one page by using the intermediate data and performance evaluation information representing a reference value for evaluating the expected time to be spent on RIP processing. That is, a time to be spent on RIP processing that will be performed later is expected by using intermediated data, which is data in a stage preceding conversion into raster data.

Here, performance evaluation information is information in which an attribute of data included in intermediated data is associated in advance with an expected time to be spent on conversion into raster data. Thus, the RIP performance evaluating unit 105 calculates an expected time to be spent on RIP processing on intermediate data corresponding to one page by using an attribute of data included in the intermediate data and performance evaluation information. Here, an attribute of data is the type of a primitive figure, for example, a character, a line segment, a circle, or the like. In a case where the attribute of data is character, an expected time to be spent on RIP processing for the character is predetermined as performance evaluation information, for example, “0.00001 minutes” per character.

The performance evaluation information may be information in which an amount of intermediate data, not an attribute of data included in intermediate data, is associated in advance with an expected time to be spent on conversion into raster data. In this case, the RIP performance evaluating unit 105 calculates an expected time to be spent on RIP processing on intermediate data corresponding to one page by using the amount of the intermediate data and performance evaluation information. In this exemplary embodiment, performance evaluation information is used as an example of a correspondence.

In this way, the RIP performance evaluating unit 105 calculates, for each page of intermediate data, an expected time to be spent on RIP processing. After calculating expected times to be spent on RIP processing on individual pages, the RIP performance evaluating unit 105 averages the calculated expected times to calculate an average value of an expected time to be spent on RIP processing per page (hereinafter referred to as an expected RIP average time). In this exemplary embodiment, intermediate data corresponding to one page is used as an example of a predetermined amount of intermediate data.

Whether to use a value determined in accordance with an attribute of data or a value determined in accordance with an amount of data as performance evaluation information is predetermined by a setting. Also, the number of pages for which an expected RIP average time is to be calculated is predetermined by a setting. That is, in the case of calculating an expected RIP average time for intermediate data, the RIP performance evaluating unit 105 calculates the expected RIP average time for intermediate data of a predetermined number of pages from the top page of print data transmitted from the host computer 20.

The performance evaluation information storage unit 106 stores performance evaluation information generated by a user or the like. As described above, the performance evaluation information is used by the RIP performance evaluating unit 105 to calculate an expected time to be spent on RIP processing on intermediate data corresponding to one page.

The printing speed list storage unit 107 stores a printing speed list in which printing speeds adoptable for print processing performed by the print mechanism unit 200 are registered in advance. In this printing speed list, printing speeds adoptable in terms of the performance of the print mechanism unit 200 are registered in advance. For example, plural printing speeds, such as three printing speeds Tₘₐₓ, T_{mid}, and Tₘᵢₙ, are registered therein.

The printing speed selecting unit 108, which is an example of a selecting section, selects any one of the printing speeds registered in the printing speed list. First, the printing speed selecting unit 108 obtains an expected RIP average time calculated by the RIP performance evaluating unit 105. Subsequently, the printing speed selecting unit 108 divides a unit page length, which is the length of continuous paper of one page, by the expected RIP average time, which is an average value of an expected time to be spent on RIP processing per page, so as to calculate an expected maximum speed.

The expected maximum speed is a printing speed at which the print mechanism unit 200 is assumed to perform printing on continuous paper of one page in the expected RIP average time, and is a value corresponding to RIP processing per page. In addition, the expected maximum speed is an expected maximum printing speed at which printing is expected to be performed without delay in preparation of raster data.

That is, it is estimated that, in a case where printing is performed at the expected maximum speed or a lower speed, printing will be performed with raster data being prepared through RIP processing. On the other hand, it is estimated that, in a case where printing is performed at a speed higher than the expected maximum speed, RIP processing will not keep up with the speed, raster data will not be prepared, and continuous printing will not be performed to stop. Thus, the printing speed selecting unit 108 selects the highest speed not exceeding the estimated maximum speed from among the printing speeds registered in the printing speed list. Then, the printing speed selecting unit 108 outputs a control instruction for setting the selected printing speed to the mechanism controller 109.

The mechanism controller 109 sequentially outputs pieces of raster data received from the RIP processing unit 104 to the print mechanism unit 200. Also, the mechanism controller 109 outputs the control instruction for setting the printing speed selected by the printing speed selecting unit 108 to the print mechanism unit 200. Accordingly, the print mechanism unit 200 sequentially prints the received pieces of raster data at the printing speed selected by the printing speed selecting unit 108.

### Description of Performance Evaluation Information

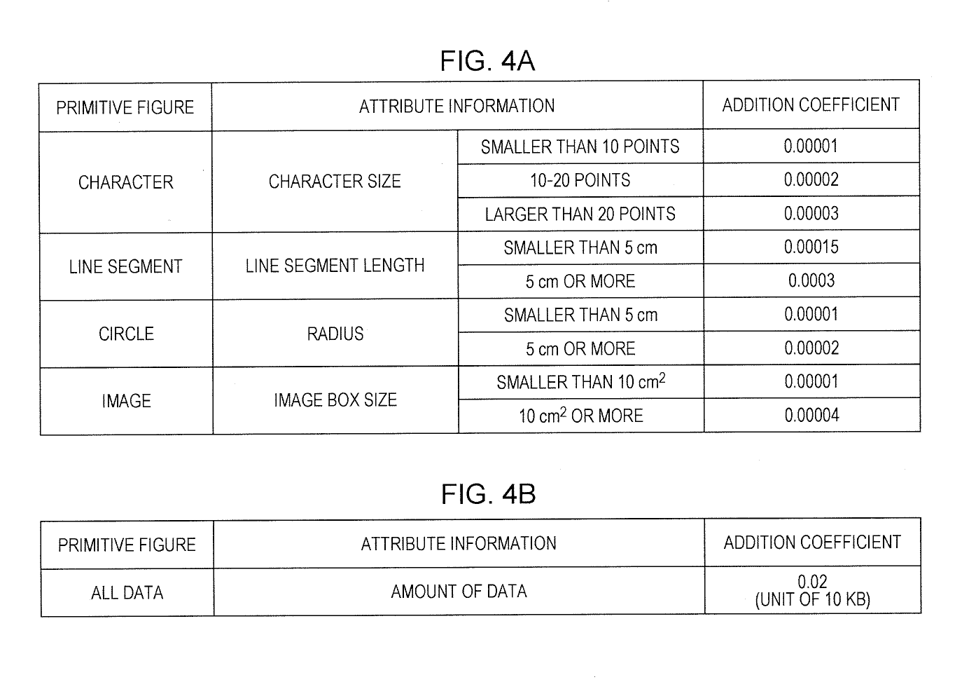

The performance evaluation information stored in the performance evaluation information storage unit 106 will be described. FIGS. 4A and 4B are diagrams illustrating an example of the performance evaluation information.

The performance evaluation information illustrated in FIG. 4A represents expected times to be spent on RIP processing, which are defined in accordance with attributes of data. In the example illustrated in FIG. 4A, “character”, “line segment”, “circle”, and “image” are defined as primitive figures. “Image” is a figure other than “character”, “line segment”, and “circle”. Also, addition coefficients are defined for the individual primitive figures. The addition coefficients are coefficients for calculating expected times to be spent on RIP processing.

For example, it is assumed that a primitive figure is “character”. In this case, the addition coefficient is “0.00001” in a case where the character size is smaller than 10 points, the addition coefficient is “0.00002” in a case where the character size is 10 to 20 points, and the addition coefficient is “0.00003” in a case where the character size is larger than 20 points. In a case where a page includes 1000 characters each having a size of 5 points, an expected time to be spent on RIP processing on intermediate data of the page is calculated as follows: an addition coefficient (=0.00001)×the number of characters (=1000)=0.01 minutes.

The performance evaluation information illustrated in FIG. 4B represents expected times to be spent on RIP processing, which are defined in accordance with an amount of data. In the example illustrated in FIG. 4B, it is defined that the amount of data is 10 kB and the addition coefficient is “0.02”. For example, it is assumed that the amount of intermediate data of one page is 100 kB. In this case, an expected time to be spent on RIP processing on intermediate data of the page is calculated as follows: (100 kB/10 kB)×addition coefficient (=0.02)=0.2 minutes.

A description will be given of a case where an expected RIP average time is calculated as “1/230 minutes” by using such performance evaluation information. In a case where the unit page length is 0.4 m, an estimated maximum speed is calculated as “92 m/minute” through the calculation of 0.4 m/( 1/230 minutes). Here, if three printing speeds “100 m/minute”, “90 m/minute”, and “80 m/minute” are registered in the printing speed list, the printing speed selecting unit 108 selects “90 m/minute” as the highest speed not exceeding 92 m/minute.

Procedure of Selecting Printing Speed and Performing Printing

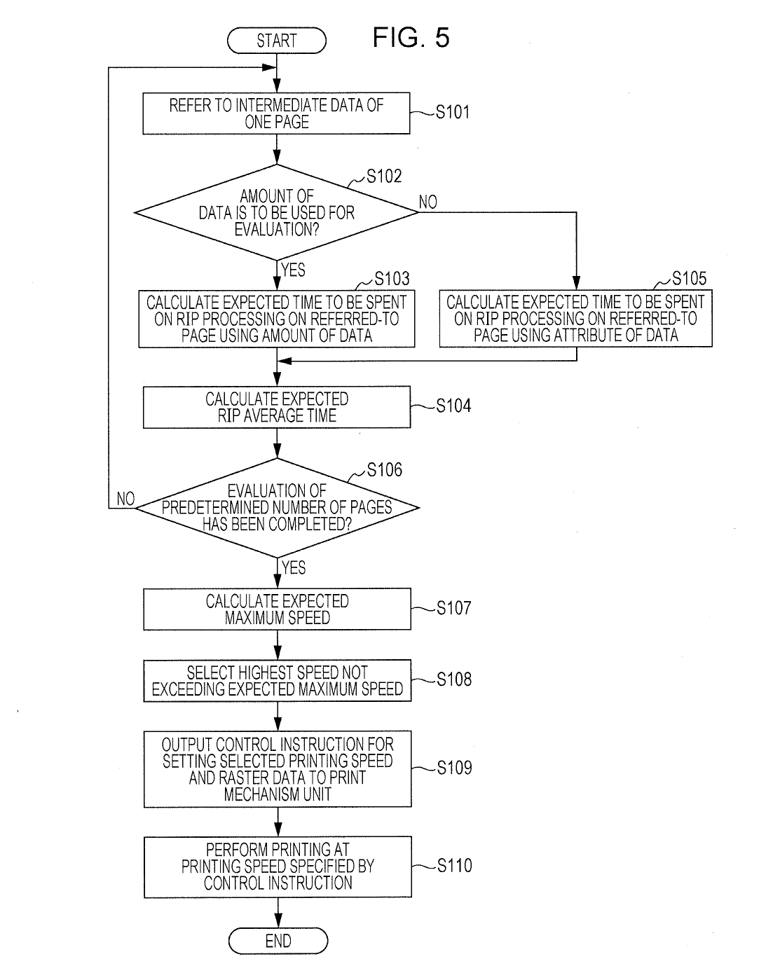

Next, a description will be given of a processing procedure in which the image forming apparatus 10 selects a printing speed and performs printing. FIG. 5 is a flowchart illustrating an example of the processing procedure in which the image forming apparatus 10 selects a printing speed and performs printing. It is assumed that, in an initial state, the host computer 20 has transmitted print data to the image forming apparatus 10. In response to the transmission of the print data, the reception processing unit 102 receives the print data. Subsequently, the print data command analyzing unit 103 analyses the print data and generates intermediate data, and the RIP processing unit 104 converts the intermediate data to generate raster data.

Here, the reception processing by the reception processing unit 102, the analysis processing by the print data command analyzing unit 103, and the RIP processing by the RIP processing unit 104 may be performed in order, or may be performed independently of one another. In a case where these processing operations are performed independently of one another, the print data command analyzing unit 103 performs analysis processing if print data is stored in the print data memory, and the RIP processing unit 104 performs RIP processing if intermediate data is stored in the intermediate data memory.

After the print data command analyzing unit 103 has generated intermediate data and stored the generated intermediate data in the intermediate data memory, the RIP performance evaluating unit 105 selects and refers to intermediate data of one page that has not yet been referred to in the intermediate data stored in the intermediate data memory (step S101). Here, the RIP performance evaluating unit 105 selects one page by one from the top page of the intermediate data. Subsequently, the RIP performance evaluating unit 105 determines whether or not a setting for using performance evaluation information defined in accordance with the amount of data has been made regarding an evaluation method (step S102).

If it is determined that a setting for using performance evaluation information defined in accordance with the amount of data has been made (YES in step S102), the RIP performance evaluating unit 105 calculates an expected time to be spent on RIP processing on intermediate data of the referred-to page by using the amount of intermediate data of the page and the performance evaluation information stored in the performance evaluation information storage unit 106 (step S103). Subsequently, the RIP performance evaluating unit 105 averages the expected times to be spent on RIP processing calculated for individual pages, that is, the pages from the top page to the page that is currently referred to of the intermediate data, and thereby calculates an expected RIP average time (step S104).

On the other hand, if it is determined in step S102 that a setting for using performance evaluation information defined in accordance with the amount of data has not been made (NO in step S102), it means that a setting for using performance evaluation information defined in accordance with an attribute of data has been made. Thus, the RIP performance evaluating unit 105 calculates an expected time to be spent on RIP processing on intermediate data of the referred-to page by using the attribute of data included in the intermediate data of the page and the performance evaluation information stored in the performance evaluation information storage unit 106 (step S105). Specifically, the RIP performance evaluating unit 105 detects primitive figures in the intermediate data of the page, and calculates the sum of addition coefficients of the detected primitive figures. The sum corresponds to an expected time to be spent on RIP processing on the intermediate data of the page. After that, the processing proceeds to step S104.

Subsequently, the RIP performance evaluating unit 105 determines, in order to calculate an expected RIP average time, whether or not evaluation of a predetermined number of pages from the top page of the intermediate data has been completed (step S106). If it is determined that evaluation of the predetermined number of pages has not been completed (NO in step S106), the processing returns to step S101. On the other hand, if it is determined that evaluation of the predetermined number of pages has been completed (YES in step S106), the printing speed selecting unit 108 divides a unit page length by the expected RIP average time, which is an evaluation result of the predetermined number of pages, and thereby calculates an expected maximum speed (step S107).

Subsequently, the printing speed selecting unit 108 selects the highest speed not exceeding the calculated expected maximum speed from among the printing speeds registered in the printing speed list (step S108). Subsequently, the printing speed selecting unit 108 outputs a control instruction for setting the selected printing speed to the mechanism controller 109. Subsequently, the mechanism controller 109 outputs the control instruction for setting the printing speed selected by the printing speed selecting unit 108 to the print mechanism unit 200, and also sequentially outputs pieces of raster data received from the RIP processing unit 104 to the print mechanism unit 200 (step S109). Subsequently, the print mechanism unit 200 performs printing at the printing speed specified by the control instruction (step S110). Here, the mechanism controller 109 outputs the control instruction for setting the printing speed to the print mechanism unit 200 before outputting the raster data to the print mechanism unit 200, and accordingly printing is performed at the printing speed specified by the control instruction. After that, this processing flow ends.

As described above, the image forming apparatus 10 according to this exemplary embodiment calculates, for each page of intermediate data, an expected time to be spent on RIP processing. Subsequently, the image forming apparatus 10 averages the expected times to be spent on RIP processing to calculate an expected RIP average time, and further calculates an expected maximum speed. Subsequently, the image forming apparatus 10 selects the highest speed not exceeding the expected maximum speed from among printing speeds adoptable in the print mechanism unit 200.

In a configuration according to the related art, for example, the RIP performance evaluating unit 105 and the printing speed selecting unit 108 illustrated in FIG. 3 are not included. Therefore, in some cases, RIP processing does not keep up with a printing speed and printing is stopped depending on the complexity and amount of print data. In other cases, the printing speed is lower than the speed of RIP processing, raster data generated through the RIP processing is accumulated, and printing is performed at a set printing speed although faster printing is possible.

On the other hand, the image forming apparatus 10 according to this exemplary embodiment evaluates the complexity and amount of data before performing RIP processing, and selects a printing speed by determining a printing speed at which printing will be able to be performed without a stop. Further, the image forming apparatus 10 according to this exemplary embodiment selects the highest speed from among the speeds at which printing is expected to be performed without a stop.

In this exemplary embodiment, the RIP performance evaluating unit 105 calculates an expected maximum speed by using an expected RIP average time. Alternatively, for example, the RIP performance evaluating unit 105 may calculate an expected maximum speed by using an expected time to be spent on RIP processing on intermediate data corresponding to plural pages. In this case, the printing speed selecting unit 108 calculates the expected maximum speed by dividing the length of continuous paper of the plural pages by an expected time to be spent on RIP processing on the intermediate data corresponding to the plural pages.

### Second Exemplary Embodiment

Next, an image forming apparatus 10 according to a second exemplary embodiment will be described. In the first exemplary embodiment, the image forming apparatus 10 calculates an expected time to be spent on RIP processing by using intermediate data to calculate an expected RIP average time, calculates an expected maximum speed by using the calculated RIP average time, and sets a printing speed. In contrast, the image forming apparatus 10 according to the second exemplary embodiment calculates a time actually spent on analysis processing and RIP processing on print data, instead of calculating an expected time to be spent on RIP processing by using intermediate data, and sets a printing speed.

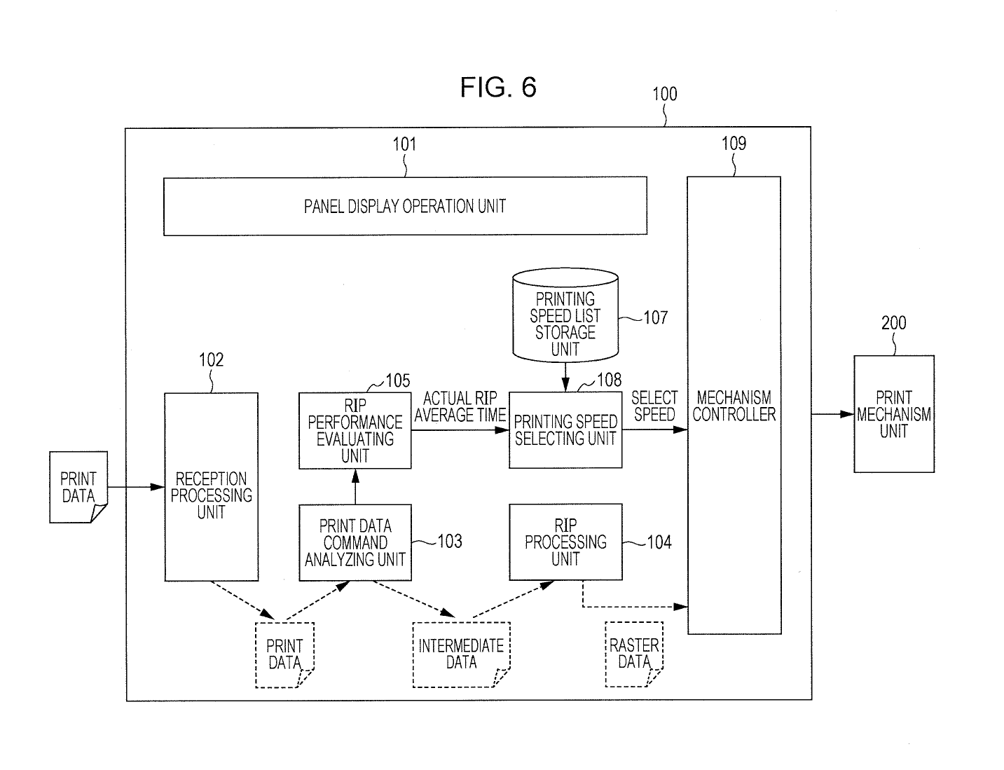

FIG. 6 is a block diagram illustrating an example of the functional configuration of the controller 100 included in the image forming apparatus 10 according to the second exemplary embodiment. The panel display operation unit 101, the reception processing unit 102, the printing speed list storage unit 107, and the mechanism controller 109 according to the second exemplary embodiment function similarly to those according to the first exemplary embodiment. Note that the image forming apparatus 10 according to the second exemplary embodiment does not calculate an expected time to be spent on RIP processing by using intermediate data, and thus does not include the performance evaluation information storage unit 106.

The print data command analyzing unit 103 analyzes the print data stored in the print data memory and generates intermediate data. In the analysis processing, the print data command analyzing unit 103 stores a start time and end time of the analysis processing for each page in the intermediate data memory.

The RIP processing unit 104 performs RIP processing on the intermediate data stored in the intermediate data memory so as to convert the intermediate data into raster data. In the RIP processing, the RIP processing unit 104 stores a start time and end time of the RIP processing for each page in the raster data memory.

After analysis processing and RIP processing have been performed on a predetermined number of pages from the top page of print data received from the host computer 20, the RIP performance evaluating unit 105 calculates, for each page, a time actually spent on the analysis processing and

RIP processing. Subsequently, the RIP performance evaluating unit 105 divides the calculated time by the predetermined number of pages to calculate an average time. The average time calculated here is the time actually spent on the analysis processing and RIP processing on one page of the print data, and is referred to as an actual RIP average time. In addition, the actual RIP average time is a time calculated by using an actual processing time, and is an expected time to be spent on preparing raster data corresponding to one page from the print data. In this exemplary embodiment, raster data corresponding to one page is used as an example of a predetermined amount of raster data.

The printing speed selecting unit 108 selects any one of the printing speeds registered in the printing speed list. Here, the printing speed selecting unit 108 divides a unit page length by an actual RIP average time, which is an average value of the time actually spent on analysis processing and RIP processing per page, so as to calculate an actual maximum speed.

The actual maximum speed is a printing speed at which the print mechanism unit 200 is assumed to perform printing on continuous paper of one page in the actual RIP average time, and is a value corresponding to the analysis processing and RIP processing per page. In addition, the actual maximum speed is a maximum speed at which printing is expected to be performed without delay in preparing raster data from print data through analysis processing and RIP processing.

That is, it is estimated that, in a case where printing is performed at the actual maximum speed or a lower speed, printing will be performed with raster data being prepared through RIP processing. On the other hand, it is estimated that, in a case where printing is performed at a speed higher than the actual maximum speed, RIP processing will not keep up with the speed, raster data will not be prepared, and continuous printing will not be performed to stop. Thus, the printing speed selecting unit 108 selects the highest speed not exceeding the actual maximum speed from among the printing speeds registered in the printing speed list. Then, the printing speed selecting unit 108 outputs a control instruction for setting the selected printing speed to the mechanism controller 109.

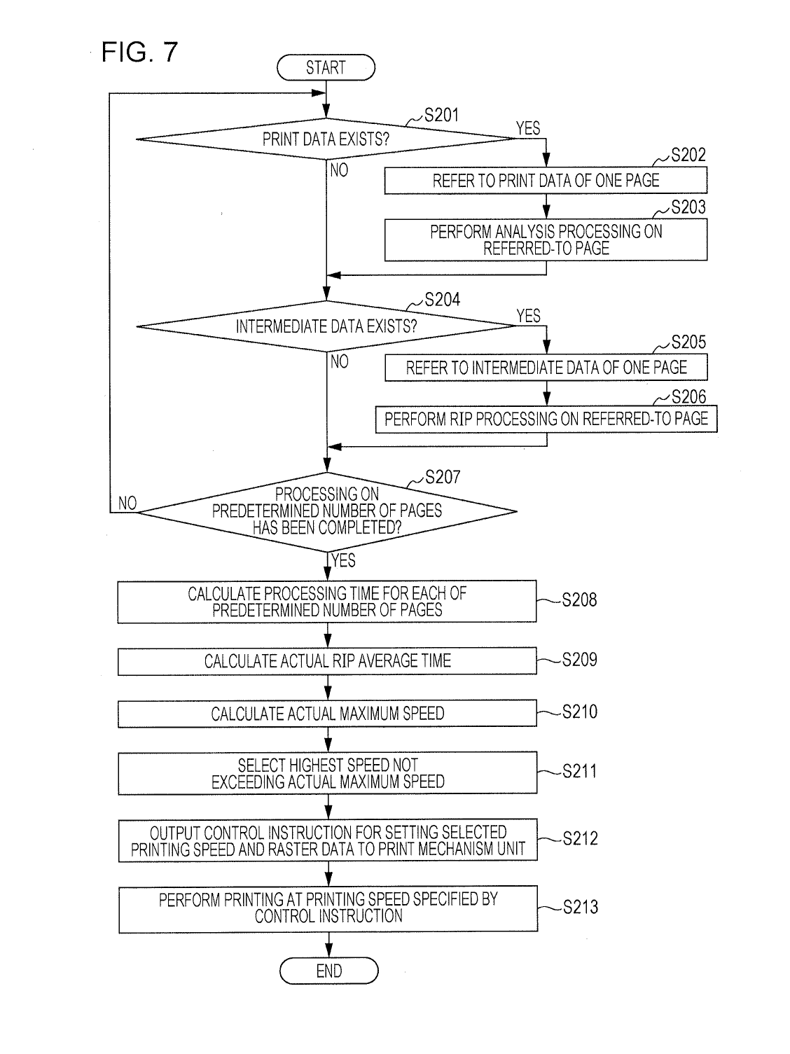

Next, a description will be given of a processing procedure in which the image forming apparatus 10 selects a printing speed and performs printing. FIG. 7 is a flowchart illustrating an example of the processing procedure in which the image forming apparatus 10 according to the second exemplary embodiment selects a printing speed and performs printing. It is assumed that, in an initial state, the host computer 20 has transmitted print data to the image forming apparatus 10. In response to the transmission of the print data, the reception processing unit 102 receives the print data.

First, the print data command analyzing unit 103 determines whether or not print data stored in the print data memory by the reception processing unit 102 exists (step S201). If it is determined that print data exists (YES in step S201), the print data command analyzing unit 103 selects and refers to print data of one page that has not yet been referred to in the print data stored in the memory (step S202). Here, the print data command analyzing unit 103 selects one page by one from the top page of the print data.

Subsequently, the print data command analyzing unit 103 performs analysis processing on the print data of the page that is referred to (step S203). Here, before starting analysis processing on the page, the print data command analyzing unit 103 records a start time in a memory. After finishing the analysis processing on the page, the print data command analyzing unit 103 records an end time in the memory. Further, the print data command analyzing unit 103 stores intermediate data generated through the analysis processing in the intermediate data memory.

After step S203, or if it is determined in step S201 that print data does not exist (NO in step S201), the RIP processing unit 104 determines whether or not intermediate data stored in the intermediate data memory by the print data command analyzing unit 103 exists (step S204). If it is determined that intermediate data exists (YES in step S204), the RIP processing unit 104 selects and refers to intermediate data of one page that has not yet been referred to in the intermediate data stored in the memory (step S205). Here, the RIP processing unit 104 selects one page one by from the top page of the intermediate data.

Subsequently, the RIP processing unit 104 performs RIP processing on the intermediate data of the one page that is referred to (step S206). Here, before starting RIP processing on the page, the RIP processing unit 104 records a start time in a memory. After finishing the RIP processing on the page, the RIP processing unit 104 records an end time in the memory. Further, the RIP processing unit 104 stores raster data generated through the RIP processing in the raster data memory and sequentially outputs pieces of the raster data to the mechanism controller 109.

After step S206, or if it is determined in step S204 that intermediate data does not exist (NO in step S204), the RIP performance evaluating unit 105 determines whether or not analysis processing and RIP processing on the predetermined number of pages of the print data have been completed (step S207). If it is determined that the processing on the predetermined number of pages has not been completed (NO in step S207), the processing returns to step S201, and processing on the print data is continuously performed.

On the other hand, if it is determined that processing on the predetermined number of pages has been completed (YES in step S207), the RIP performance evaluating unit 105 calculates a processing time for each of the predetermined number of pages from the top page by using the information recorded in the memory by the print data command analyzing unit 103 and the RIP processing unit 104 (step S208). Specifically, the RIP performance evaluating unit 105 calculates, for each page, an analysis processing time by using the start time and end time recorded for the page by the print data command analyzing unit 103. Also, the RIP performance evaluating unit 105 calculates, for each page, a RIP processing time by using the start time and end time recorded for the page by the RIP processing unit 104.

The RIP processing unit 104 calculates the sum of the analysis processing times and RIP processing times of all the pages, and divides the sum by the predetermined number of pages, so as to calculate an actual RIP average time (step S209). Subsequently, the printing speed selecting unit 108 divides a unit page length by the actual RIP average time to calculate an actual maximum speed (step S210). Subsequently, the printing speed selecting unit 108 selects the highest speed not exceeding the calculated actual maximum speed from among the printing speeds registered in the printing speed list (step S211). Steps S212 and S213 are the same as steps S109 and S110 in FIG. 5, and thus the description thereof is omitted. After that, this processing flow ends.

In the procedure illustrated in FIG. 7, processing by the print data command analyzing unit 103, processing by the RIP processing unit 104, and processing by the RIP performance evaluating unit 105 are performed in order for each page. However, as in the procedure illustrated in FIG. 5, these processing operations may be performed independently of one another. In this case, processing in steps S201 to S203, processing in steps S204 to S206, and processing in step S207 are performed in parallel. As a result, if it is determined that processing on the predetermined number of pages has been completed (YES in step S207), step S208 and the subsequent steps are performed.

In this way, the image forming apparatus 10 according to the second exemplary embodiment calculates, for each page, a time actually spent on analysis processing and RIP processing of print data. Also, the image forming apparatus 10 averages the times of the analysis processing and RIP processing to calculate an actual RIP average time, and further calculates an actual maximum speed. Also, the image forming apparatus 10 selects the highest speed not exceeding the actual maximum speed from among the printing speeds adoptable in the print mechanism unit 200.

In this exemplary embodiment, the RIP performance evaluating unit 105 calculates an actual maximum speed by using an actual RIP average time. Alternatively, for example, the RIP performance evaluating unit 105 may calculate an actual maximum speed by using a time actually spent on analysis processing and RIP processing on the print data corresponding to plural pages. In this case, the printing speed selecting unit 108 calculates the actual maximum speed by dividing the length of continuous paper of the plural pages by the time actually spent on analysis processing and RIP processing on the print data corresponding to the plural pages.

### Third Exemplary Embodiment

Next, an image forming apparatus 10 according to a third exemplary embodiment will be described. The third exemplary embodiment is the same as the first or second exemplary embodiment in terms of a hardware configuration and functional configuration, but is different in terms of the timing to change a printing speed. In the first and second exemplary embodiments, the image forming apparatus 10 sets a printing speed to be used when starting printing. In contrast, in the third exemplary embodiment, the image forming apparatus 10 sets a printing speed to be used when restarting printing after stopping printing.

Specifically, when starting printing, the printing speed selecting unit 108 selects, as a printing speed, the highest speed corresponding to the maximum performance from among the printing speeds registered in the printing speed list. While printing is in progress, the RIP performance evaluating unit 105 updates an expected RIP average time or an actual RIP average time in accordance with the processing performed by the print data command analyzing unit 103 and the RIP processing unit 104. If printing stops due to some failure, such as an error in which RIP processing does not keep up with printing or an error in analysis processing or RIP processing, the printing speed selecting unit 108 calculates an expected maximum speed by using the expected RIP average time that is calculated at the time, and selects a printing speed to be used when restarting printing. Further, in the configuration of calculating an actual RIP average time, if printing stops due to some failure, the printing speed selecting unit 108 calculates an actual maximum speed by using the actual RIP average time that is calculated at the time, and selects a printing speed to be used when restarting printing.

In this exemplary embodiment, the highest speed is selected from among adoptable printing speeds when starting printing. However, an exemplary embodiment of the present invention is not limited to this configuration, and any adoptable printing speed may be selected.

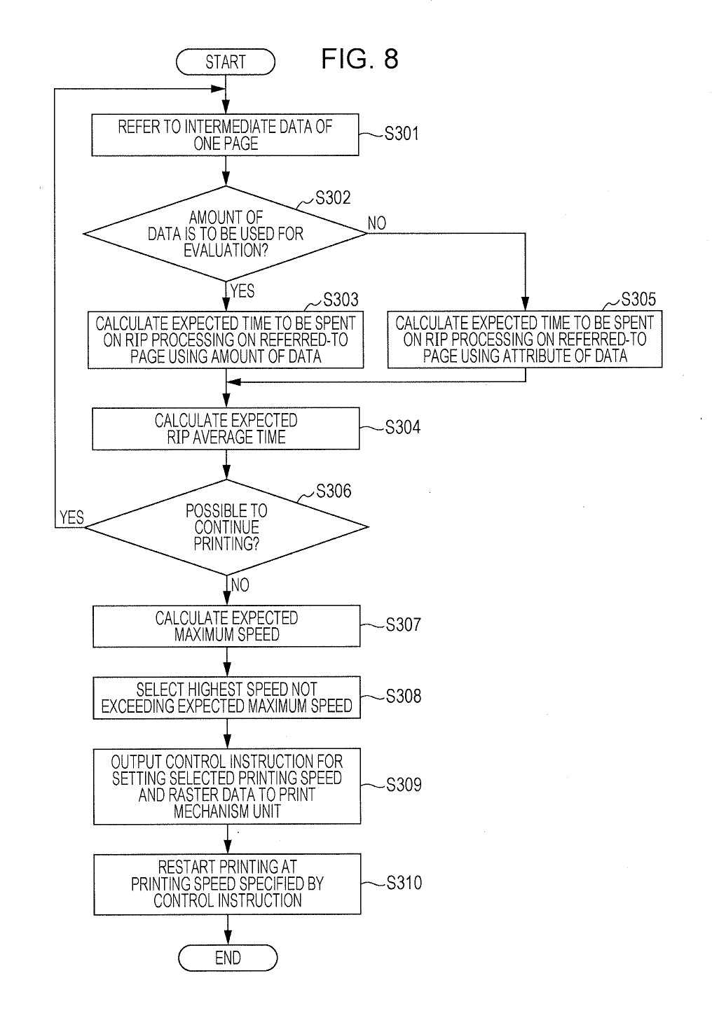

Next, a description will be given of a processing procedure in which the image forming apparatus 10 selects a printing speed and performs printing. FIG. 8 is a flowchart illustrating an example of the processing procedure in which the image forming apparatus 10 according to the third exemplary embodiment selects a printing speed and performs printing. In the example illustrated in FIG. 8, a description will be given under the assumption that the image forming apparatus 10 calculates an expected RIP average time as in the first exemplary embodiment. Also, it is assumed that, in an initial state, the highest speed among the printing speeds registered in the printing speed list is set and then printing is started.

Before printing is started, reception processing by the reception processing unit 102, analysis processing by the print data command analyzing unit 103, and RIP processing by the RIP processing unit 104 are performed, and raster data generated thereby is output to the print mechanism unit 200. Also, after printing has been started, reception processing by the reception processing unit 102, analysis processing by the print data command analyzing unit 103, and RIP processing by the RIP processing unit 104 are performed, pieces of raster data generated thereby are sequentially output to the print mechanism unit 200, and printing is performed.

The print data command analyzing unit 103 generates intermediate data and stores the generated intermediate data in the intermediate data memory, and then the RIP performance evaluating unit 105 selects and refers to intermediate data of one page that has not yet been referred to in the intermediate data stored in the memory (step S301). Steps S302 to S305 are the same as steps S102 to S105 illustrated in FIG. 5, and thus the description thereof is omitted.

Subsequently, the RIP performance evaluating unit 105 determines whether or not it is possible to continue printing, that is, whether or not printing has stopped due to some failure (step S306). If it is determined that it is possible to continue printing (YES in step S306), the processing returns to step S301, and processing of updating an expected RIP average time is continuously performed. On the other hand, if it is determined that it is not possible to continue printing (NO in step S306), the printing speed selecting unit 108 divides the unit page length by the expected RIP average time that is calculated at the time, so as to calculate an expected maximum speed (step S307).

Subsequently, the printing speed selecting unit 108 selects the highest speed not exceeding the calculated expected maximum speed from among the printing speeds registered in the printing speed list (step S308), and then outputs a control instruction for setting the selected printing speed to the mechanism controller 109. Subsequently, the mechanism controller 109 outputs the control instruction for setting the printing speed selected by the printing speed selecting unit 108 to the print mechanism unit 200, and sequentially outputs pieces of raster data stored in the memory at the time to the print mechanism unit 200 (step S309). Subsequently, the print mechanism unit 200 restarts printing at the printing speed specified by the control instruction (step S310). After that, this processing flow ends.

After printing has been restarted, the processing illustrated in FIG. 8 is repeatedly performed until the print job ends. That is, in a case where printing stops again after restarting, an expected maximum speed is calculated by using the expected RIP average time calculated at the time, and a printing speed is selected again.

In the procedure illustrated in FIG. 8, an expected RIP average time is calculated. Alternatively, the image forming apparatus 10 may calculate an actual RIP average time as in the second exemplary embodiment. In this case, the RIP performance evaluating unit 105 calculates an actual RIP average time in step S304. If printing stops, the printing speed selecting unit 108 calculates an actual maximum speed by using the actual RIP average time that is calculated at the time, and selects a printing speed.

In this way, the image forming apparatus 10 according to the third exemplary embodiment selects the highest speed from among adoptable printing speeds when starting printing. During printing, the image forming apparatus 10 updates an expected RIP average time or an actual RIP average time. If printing stops due to some failure, the image forming apparatus 10 selects a printing speed by using the expected RIP average time or the actual RIP average time at the time.

### Fourth Exemplary Embodiment

Next, an image forming apparatus 10 according to a fourth exemplary embodiment will be described. The fourth exemplary embodiment is the same as any of the first to third exemplary embodiments in terms of a hardware configuration and functional configuration, but is different in terms of the timing to change a printing speed and a procedure of selecting a printing speed. The image forming apparatus 10 according to the fourth exemplary embodiment selects a printing speed by considering the amount of data on which analysis processing and RIP processing have already been performed, when restarting printing after printing has stopped due to some failure.

Even if printing stops due to some failure, analysis processing and RIP processing in the controller 100 may be continuously performed. In that case, analyzed intermediate data and RIP-processed raster data have been accumulated at the time of restarting printing. With the accumulation of data being taken into consideration, faster printing is allowed compared to a case where no data is accumulated. In this exemplary embodiment, the image forming apparatus 10 grasps the amount of accumulated data by using information representing the number of pages on which analysis processing has been performed and the number of pages on which RIP processing has been performed. Subsequently, the image forming apparatus 10 corrects an expected RIP average time or an actual RIP average time in consideration of the amount of accumulated data and selects a printing speed.

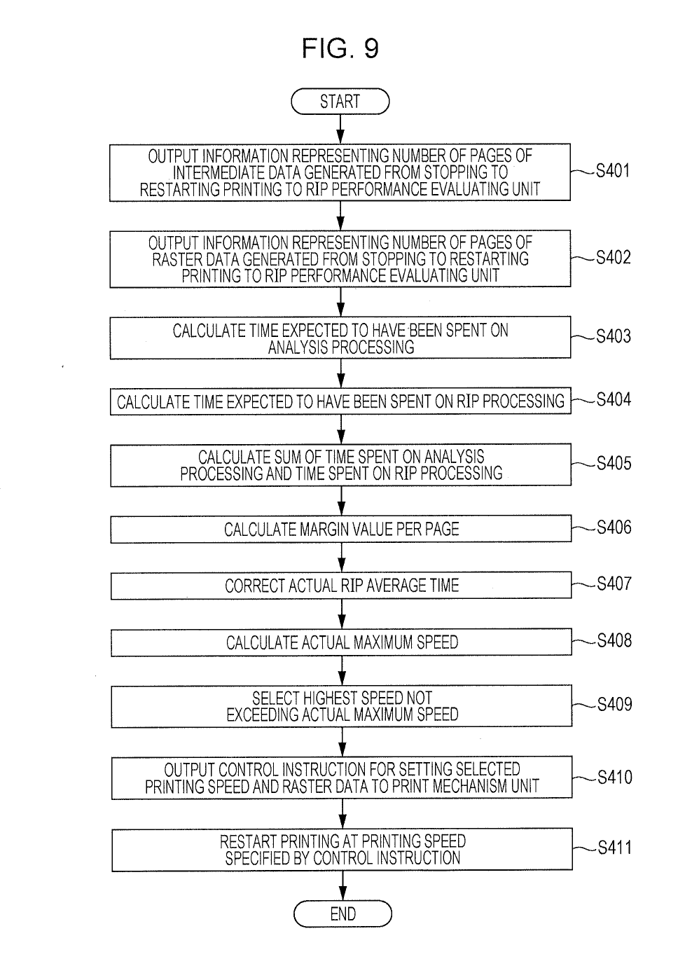

Next, a description will be given of a processing procedure in which the image forming apparatus 10 selects a printing speed and performs printing. FIG. 9 is a flowchart illustrating an example of the processing procedure in which the image forming apparatus 10 according to the fourth exemplary embodiment selects a printing speed and performs printing. In the example illustrated in FIG. 9, a description will be given under the assumption that the image forming apparatus 10 calculates an actual RIP average time as in the second exemplary embodiment. Also, it is assumed that, in an initial state, printing has stopped due to some failure.

If printing stops due to some failure, the print data command analyzing unit 103 outputs information representing the number of pages of intermediate data generated from stopping to restarting printing to the RIP performance evaluating unit 105 (step S401). The number of pages of intermediate data includes the number of pages of raster data obtained through conversion from intermediate data performed by the RIP processing unit 104. The RIP processing unit 104 outputs information representing the number of pages of raster data generated from stopping to restarting printing to the RIP performance evaluating unit 105 (step S402).

During printing, the print data command analyzing unit 103 performs steps S202 and S203 illustrated in FIG. 7 and records the start time and end time of analysis processing for each page in a memory. Also, during printing, the RIP processing unit 104 performs steps S205 and S206 illustrated in FIG. 7, and records the start time and end time of RIP processing for each page in a memory. Thus, an average time of analysis processing per page and an average time of RIP processing per page may be calculated.

In response to reception of the information representing the number of pages of intermediate data generated from stopping to restarting printing, the RIP performance evaluating unit 105 multiplies the number of pages by the average time of analysis processing per page to calculate the time expected to have been spent on the analysis processing (step S403). Also, the RIP performance evaluating unit 105 multiplies the number of pages of raster data generated from stopping to restarting printing by the average time of RIP processing per page to calculate the time expected to have been spent on the RIP processing (step S404).

The RIP performance evaluating unit 105 calculates the sum of the time calculated in step S403 and the time calculated in step S404 (step S405). The sum of the times (hereinafter referred to as a margin value) is a time spent on the analysis processing and RIP processing performed after printing has stopped, and is an index indicating the amount of accumulated data. Compared to a case where data is not accumulated, it is allowed to increase the printing speed by the sum of the times.

Subsequently, the RIP performance evaluating unit 105 divides the margin value calculated in step S405 by the number of pages that have not yet been printed among all the pages to be printed in response to an instruction of a print job, so as to calculate a margin value per page (step S406). Subsequently, the RIP performance evaluating unit 105 subtracts the calculated margin value per page from the actual RIP average time, so as to correct the actual RIP average time (step S407). Subsequently, the printing speed selecting unit 108 divides the unit page length by the corrected actual RIP average time to calculate an actual maximum speed (step S408).

Subsequently, the printing speed selecting unit 108 selects the highest speed not exceeding the calculated actual maximum speed from among the printing speeds registered in the printing speed list (step S409), and outputs a control instruction for setting the selected printing speed to the mechanism controller 109. Subsequently, the mechanism controller 109 outputs the control instruction for setting the printing speed selected by the printing speed selecting unit 108 to the print mechanism unit 200, and further outputs the raster data stored in the memory at the time to the print mechanism unit 200 (step S410). Subsequently, the print mechanism unit 200 restarts printing at the printing speed specified by the control instruction (step S411). After that, this processing flow ends.

For example, it is assumed that an average time of analysis processing per page is “ 1/460 minutes” and an average time of RIP processing per page is “ 1/460 minutes”. In a case where the actual RIP average time is not corrected as in the second exemplary embodiment, the actual RIP average time is calculated as “ 1/230 minutes” by adding both the average times. In a case where the unit page length is 0.4 m, an actual maximum speed is calculated as “92 m/minute” through the calculation 0.4 m/( 1/230 minutes).

Hereinafter, a description will be given of the case of correcting an actual RIP average time as in this exemplary embodiment. Here, in a case where the number of pages of intermediate data generated from stopping to restarting printing is “100 pages”, the time expected to have been spent on analysis processing is “100/460 minutes”. Also, in a case where the number of pages of raster data generated from stopping to restarting printing is “25 pages”, the time expected to have been spent on RIP processing is “ 25/460 minutes”. Thus, a margin value is calculated as “125/460 minutes” by adding both the times.

In a case where the total number of pages to be printed in a print job is “500 pages” and the number of printed pages is “250 pages”, the number of pages that have not yet been printed is “250 pages”. Thus, a margin value per page is calculated as “ 1/920 minutes” through the calculation (125/460 minutes)/250 pages. Thus, a corrected actual RIP average time is calculated as “ 3/920 minutes” through the calculation ( 1/230− 1/920) minutes. An actual maximum speed is calculated as “122 m/minute” through the calculation 0.4 m/( 3/920 minutes), which is higher than the actual maximum speed before correction. As a result, the upper limit of a printing speed selectable by the printing speed selecting unit 108 is raised.

In the procedure illustrated in FIG. 9, an actual RIP average time is calculated. Alternatively, the image forming apparatus 10 may calculate an expected RIP average time as in the first exemplary embodiment. In the first exemplary embodiment, an expected time to be spent on RIP processing is calculated for each page, but a time related to analysis processing is not calculated. Thus, the RIP performance evaluating unit 105 regards a value calculated by multiplying the number of pages of raster data generated from stopping to restarting printing by an expected RIP average time as a margin value. Also in the configuration according to the first exemplary embodiment, the start time and end time of analysis processing for each page may be recorded in a memory, a time estimated to have been spent on analysis processing may be calculated as in step S403, and the calculated time may be added to the margin value. In this way, the image forming apparatus 10 according to the fourth exemplary embodiment calculates an amount of processed data accumulated from stopping to restarting printing as a margin value, and subtracts the margin value from an expected RIP average time or actual RIP average time to perform correction. The expected RIP average time or actual RIP average time becomes shorter through the correction, and thus an expected maximum speed or an actual maximum speed increases. As a result, the upper limit of a printing speed selectable by the printing speed selecting unit 108 is raised compared to that before correction.

In this exemplary embodiment, the image forming apparatus 10 selects a printing speed in consideration of a margin value to be used when restarting printing. Alternatively, the image forming apparatus 10 may restart printing when the margin value is increased after analysis processing and RIP processing proceed. For example, the image forming apparatus 10 may continue a printing stop state until a margin value that enables the highest printing speed among adoptable printing speeds to be set is obtained, and may restart printing when the margin value reaches a value satisfying a condition.

In this case, the RIP performance evaluating unit 105 divides the unit page length by the highest printing speed adoptable in the print mechanism unit 200, so as to calculate a corrected actual RIP average time (or expected RIP average time). Subsequently, the RIP performance evaluating unit 105 subtracts the corrected actual RIP average time from the uncorrected actual RIP average time (or expected RIP average time), so as to calculate a margin value. When the sum of the time expected to have been spent on analysis processing and the time expected to have been spent on RIP processing reaches the margin value after the analysis processing and RIP processing proceed, the print mechanism unit 200 start printing.

### Fifth Exemplary Embodiment

Next, an image forming apparatus 10 according to a fifth exemplary embodiment will be described. In the first to fourth exemplary embodiments, an image is formed on one surface of continuous paper by using one image forming apparatus 10. In the fifth exemplary embodiment, two image forming apparatuses 10 are connected to each other to form images on both surfaces of continuous paper. Here, one of the image forming apparatuses 10 performs printing on a front surface whereas the other image forming apparatus 10 performs printing on a back surface, and thus double-sided printing is not normally performed if the printing speeds of the two apparatuses are different. Thus, in this exemplary embodiment, the two image forming apparatuses 10 exchange information and operate at the same printing speed to perform printing.

Hereinafter, the two image forming apparatuses 10 are referred to as an image forming apparatus 10A and an image forming apparatus 10B. The image forming apparatus 10A includes a controller 100A and a print mechanism unit 200A, and the image forming apparatus 10B includes a controller 100B and a print mechanism unit 200B. The print mechanism unit 200A forms an image on a front surface of continuous paper, and the print mechanism unit 200B forms an image on a back surface of the continuous paper. In this exemplary embodiment, the print mechanism unit 200A is used as an example of a first print mechanism unit, and the print mechanism unit 200B is used as an example of a second print mechanism unit.

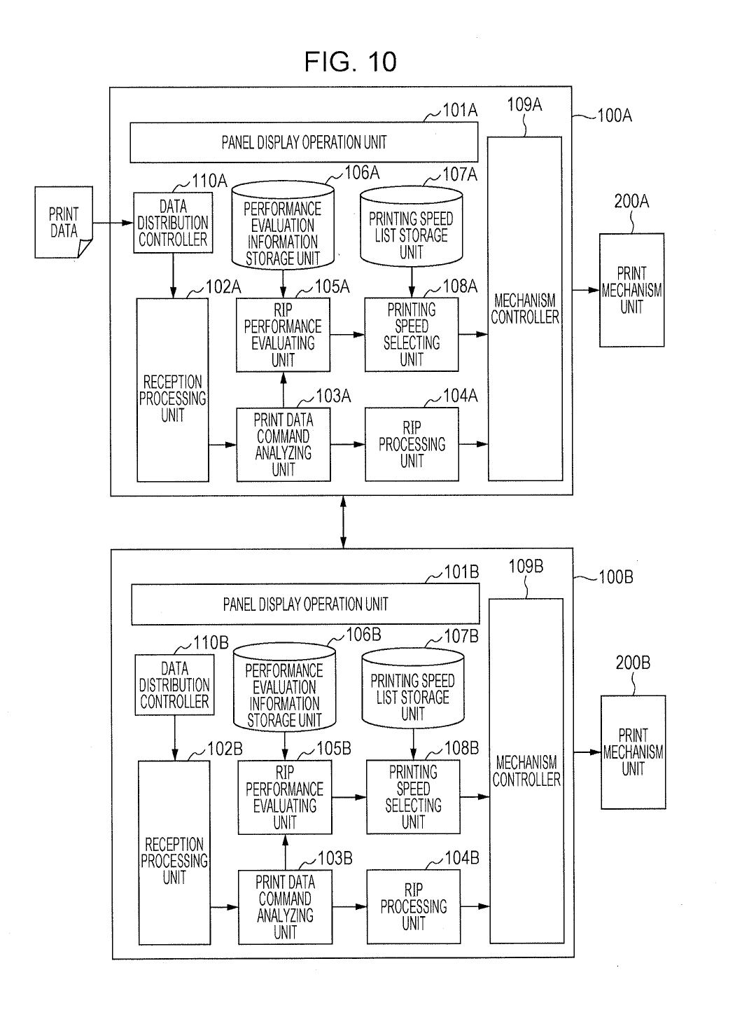

FIG. 10 is a block diagram illustrating an example of the functional configuration of the controllers 100A and 100B according to the fifth exemplary embodiment. The controller 100A includes a data distribution controller 110A in addition to the functional units of the controller 100 according to the first exemplary embodiment illustrated in FIG. 3. Likewise, the controller 100B includes a data distribution controller 110B in addition to the functional units of the controller 100 illustrated in FIG. 3.

In response to reception of print data transmitted from the host computer 20, the data distribution controller 110A of the controller 100A determines whether or not the received print data is data for the front surface. If the received print data is data for the front surface, the data distribution controller 110A outputs the received print data to a reception processing unit 102A of the controller 100A. On the other hand, if the received print data is data for tha back surface, the data distribution controller 110A outputs the received print data to the data distribution controller 110B of the controller 100B. The data distribution controller 110B outputs the print data received from the data distribution controller 110A to a reception processing unit 102B of the controller 100B.

A printing speed selecting unit 108A of the controller 100A and a printing speed selecting unit 108B of the controller 100B calculate respective expected maximum speeds, and exchange information representing the calculated expected maximum speeds. Then, the printing speed selecting units 108A and 108B select the lower one of the two expected maximum speeds, and select the highest speed not exceeding the selected expected maximum speed from a printing speed list. After that, printing is performed at the selected printing speed.

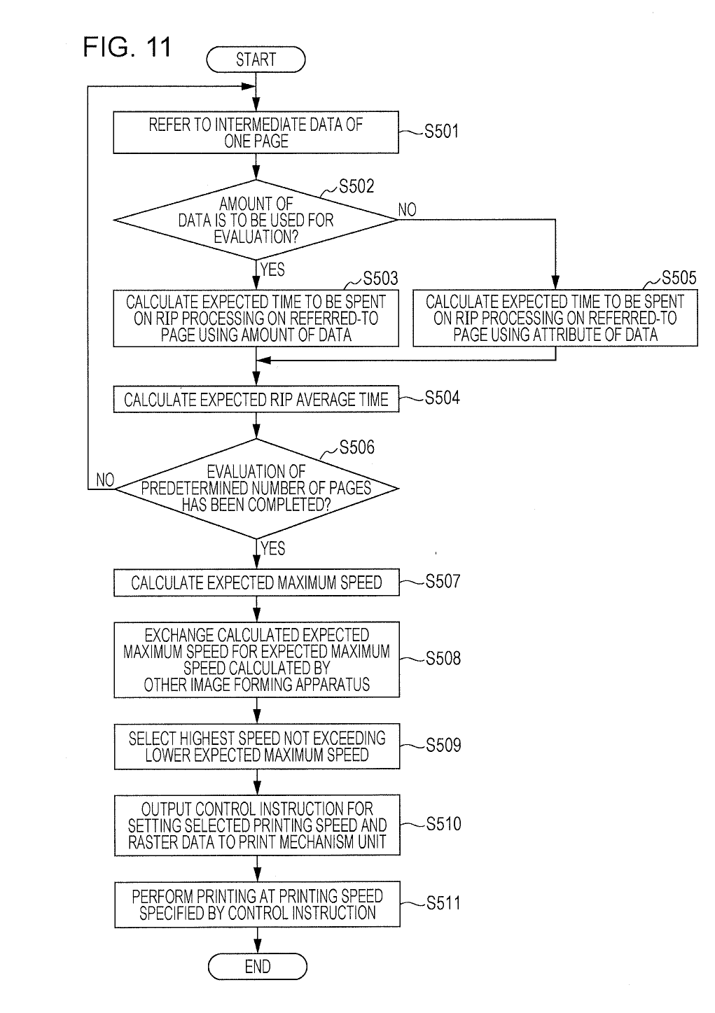

Next, a description will be given of a processing procedure in which a printing speed is selected and printing is performed in the image forming system 1 according to this exemplary embodiment. FIG. 11 is a flowchart illustrating an example of the processing procedure in which the image forming apparatus 10A according to the fifth exemplary embodiment selects a printing speed and performs printing. In the example illustrated in FIG. 11, a description will be given under the assumption that the image forming apparatus 10A calculates an expected RIP average time as in the first exemplary embodiment. Also, it is assumed that, in an initial state, the host computer 20 has transmitted print data to the image forming apparatus 10A.

When print data is transmitted from the host computer 20, the data distribution controller 110A of the image forming apparatus 10A receives the print data. Subsequently, the data distribution controller 110A determines whether or not the received print data is data for the front surface. If the received print data is data for the front surface, the data distribution controller 110A outputs the received print data to the reception processing unit 102A. On the other hand, if the received print data is data for the back surface, the data distribution controller 110A outputs the received print data to the data distribution controller 110B of the image forming apparatus 10B. The data distribution controller 110B outputs the print data received from the data distribution controller 110A to the reception processing unit 102B. In this way, the reception processing units 102A and 102B receive print data, and then analysis processing and RIP processing are performed.

A print data command analyzing unit 103A generates intermediate data and stores the generated intermediate data in an intermediate data memory. After that, steps S501 to S507 are performed by a RIP performance evaluating unit 105A. Steps S501 to S507 are the same as steps S101 to S107 illustrated in FIG. 5, and thus the description thereof is omitted.

Subsequently, a printing speed selecting unit 108A calculates an expected maximum speed in step S507, and then exchanges the calculated expected maximum speed for an expected maximum speed calculated by the image forming apparatus 10B connected thereto (step S508). That is, the printing speed selecting unit 108A transmits the calculated expected maximum speed to the printing speed selecting unit 108B of the image forming apparatus 10B, and the printing speed selecting unit 108B receives the calculated expected maximum speed. Subsequently, the printing speed selecting unit 108A compares the expected maximum speed calculated thereby with the expected maximum speed calculated by the printing speed selecting unit 108B, and selects the lower one of the expected maximum speeds.

The printing speed selecting unit 108A selects the highest speed not exceeding the lower expected maximum speed from among the printing speeds registered in the printing speed list (step S509). Subsequently, the printing speed selecting unit 108A outputs a control instruction for setting the selected printing speed to a mechanism controller 109A. Steps S510 and S511 are the same as steps S109 and S110 illustrated in FIG. 5, and thus the description thereof is omitted. After that, this processing flow ends.

The processing procedure of the image forming apparatus 10A has been described above as the procedure illustrated in FIG. 11. Processing is performed in the same manner also in the image forming apparatus 10B. That is, in the image forming apparatus 10B, in response to reception of print data from the data distribution controller 110A of the image forming apparatus 10A, a print data command analyzing unit 103B generates intermediate data and stores the generated intermediate data in an intermediate data memory. Accordingly, a RIP performance evaluating unit 105B starts step S501, and the subsequent steps are performed.

In general, in the case of performing double-sided printing by connecting two image forming apparatuses 10, apparatuses of the same model are used as the two image forming apparatuses 10. In this case, the printing speed list is also the same, and thus the two image forming apparatuses 10 select a common printing speed in step S509. However, to confirm that a common printing speed has been selected by the two image forming apparatuses 10 in step S509, the printing speed selecting units 108A and 108B may select a printing speed and then exchange information representing the selected printing speed.

In this way, in the image forming system 1 according to the fifth exemplary embodiment, the two image forming apparatuses 10 are connected to each other and exchange information to perform printing at the same printing speed.

In this exemplary embodiment, the two image forming apparatuses 10 exchange information representing an expected maximum speed to operate at the same printing speed, but an exemplary embodiment of the present invention is not limited to this configuration. For example, the two image forming apparatuses 10 may exchange information representing an expected RIP average time to operate at the same printing speed. In this case, the image forming apparatuses 10A and 10B may select the longer one of the expected RIP average times calculated thereby and calculate a common expected maximum speed.

Further, the image forming apparatus 10A may select, based on the expected maximum speed calculated thereby, the highest speed not exceeding the expected maximum speed from among the printing speeds registered in the printing speed list, and may exchange information representing the selected printing speed with the image forming apparatus 10B. In this case, the image forming apparatuses 10A and 10B may perform printing at the lower one of two printing speeds selected respectively.

Further, in this exemplary embodiment, the data distribution controller 110A of the image forming apparatus 10A selects an output destination of data in accordance with whether the data is for the front surface or back surface, but an exemplary embodiment of the present invention is not limited to this configuration. For example, the data distribution controller 110A may select an output destination of data in accordance with load states of the controllers 100 of the image forming apparatuses 10. In this case, for example, if the load of the controller 100A of the image forming apparatus 10A is high, the data distribution controller 110A outputs data for the front surface to the data distribution controller 110B of the image forming apparatus 10B. The controller 100B of the image forming apparatus 10B performs analysis processing and RIP processing on the data for the front surface.

Even in a case where an output destination is selected in accordance with the load states of the controllers 100, the print mechanism unit 200A of the image forming apparatus 10A performs printing on the front surface and the print mechanism unit 200B of the image forming apparatus 10B performs printing on the back surface. Thus, raster data for the front surface is output to the print mechanism unit 200A, and raster data for the back surface is output to the print mechanism unit 200B. In the case of calculating an expected RIP average time or an actual RIP average time, the image forming apparatuses 10A and 10B exchange information to calculate a sum. Accordingly, an expected RIP average time or an actual RIP average time related to data for the front surface is calculated, and also an expected RIP average time or an actual RIP average time related to data for the back surface is calculated. For example, an expected maximum speed related to data for the front surface is calculated by using the expected RIP average time related to data for the front surface, and the printing speed of the print mechanism unit 200A that performs printing on the front surface is selected in accordance with the calculated expected maximum speed.

The image forming apparatuses 10A and 10B according to this exemplary embodiment include the data distribution controllers 110A and 110B, respectively, in addition to the components according to the first exemplary embodiment illustrated in FIG. 3, but an exemplary embodiment of the present invention is not limited to this configuration. The image forming apparatuses 10A and 10B according to this exemplary embodiment may include the data distribution controllers 110A and 110B, respectively, in addition to the components according to any one of the second to fourth exemplary embodiments.

In the first to fifth exemplary embodiments, the image forming apparatus 10 may display information, such as a selected printing speed, an expected time to be spent on RIP processing for each page, an expected RIP average time, and an actual RIP average time, on the screen of the panel display operation unit 101 or the like, or may transmit the information to an external apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents. cm What is claimed is:

1. A print control apparatus comprising:
a generating section that generates intermediate data by analyzing print data, the intermediate data being data in a stage preceding raster data that is a group of pixels;
a converting section that converts the intermediate data generated by the generating section into the raster data;
a calculating section that calculates an expected processing time, the expected processing time being an expected time to be spent on converting a predetermined amount of intermediate data generated by the generating section into raster data; and
a selecting section that selects, as a printing speed of a print mechanism unit, any one of a plurality of predetermined speeds by using the expected processing time calculated by the calculating section.

2. The print control apparatus according to claim 1, wherein the selecting section calculates a printing speed at which the print mechanism unit is assumed to perform printing on a recording material of a number of pages corresponding to the predetermined amount of intermediate data in the expected processing time calculated by the calculating section, and selects a speed not exceeding the calculated printing speed from among the plurality of predetermined speeds.

3. The print control apparatus according to claim 1, wherein the calculating section calculates the expected processing time by using a correspondence established in advance between an attribute of data included in the intermediate data or an amount of the intermediate data and an expected time to be spent on converting the intermediate data into raster data.

4. The print control apparatus according to claim 1, wherein
the calculating section calculates a sum of an actual generation time for generating intermediate data of a predetermined number of pages by the generating section and an actual conversion time for converting the intermediate data of the predetermined number of pages into raster data by the converting section so as to calculate an actual maximum speed, and
the selecting section selects any one of the plurality of predetermined speeds by regarding the actual maximum speed as a speed corresponding to the expected processing time.

5. The print control apparatus according to claim 1, wherein
the calculating section calculates the expected processing time while the print mechanism unit is performing printing, and
the selecting section selects, as a printing speed to be used when starting printing, a speed corresponding to a maximum performance from among the plurality of predetermined speeds, and, if printing stops, selects a printing speed to be used when restarting printing by using the expected processing time calculated by the calculating section during printing.

6. The print control apparatus according to claim 1, wherein, before restarting printing after stopping printing, the calculating section corrects the expected processing time by considering the number of pages of intermediate data and the number of pages of raster data that have been generated from stopping to restarting printing.

7. The print control apparatus according to claim 1, wherein, in a case where the print control apparatus includes a first print mechanism unit that performs printing on a first surface of a recording material and a second print mechanism unit that performs printing on a second surface of the recording material,
the calculating section calculates a first expected processing time for print data to be printed by the first print mechanism unit and a second expected processing time for print data to be printed by the second print mechanism unit, and
the selecting section exchanges, between the first print mechanism unit and the second print mechanism unit, the first expected processing time and the second expected processing time that have been calculated by the calculating section, and selects, as a common printing speed of the first print mechanism unit and the second print mechanism unit, a highest speed not exceeding a speed corresponding to a longer one of the first expected processing time and the second expected processing time from among the plurality of predetermined speeds.

8. A print control apparatus comprising:
a generating section that generates intermediate data by analyzing print data, the intermediate data being data in a stage preceding raster data that is a group of pixels;
a converting section that converts the intermediate data generated by the generating section into the raster data;
a calculating section that calculates, by using an actual generation time for generating intermediate data by the generating section and an actual conversion time for converting the intermediate data into raster data by the converting section, an expected time to be spent on preparing a predetermined amount of raster data from the print data; and
a selecting section that selects, as a printing speed of a print mechanism unit, any one of a plurality of predetermined speeds by using the expected time calculated by the calculating section.

9. A printer comprising:
a printing section that has a plurality of predetermined speeds as printing speeds;
a generating section that generates intermediate data by analyzing print data, the intermediate data being data in a stage preceding raster data that is a group of pixels;
a converting section that converts the intermediate data generated by the generating section into the raster data;
a calculating section that calculates an expected processing time, the expected processing time being an expected time to be spent on converting a predetermined amount of intermediate data generated by the generating section into raster data; and
a selecting section that selects, as a printing speed of the printing section, any one of the plurality of predetermined speeds by using the expected processing time calculated by the calculating section.

10. A print control method comprising:
generating intermediate data by analyzing print data, the intermediate data being data in a stage preceding raster data that is a group of pixels;
converting the generated intermediate data into the raster data;
calculating an expected processing time, the expected processing time being an expected time to be spent on converting a predetermined amount of generated intermediate data into raster data; and
selecting, as a printing speed of a print mechanism unit, any one of a plurality of predetermined speeds by using the calculated expected processing time.

11. A non-transitory computer readable medium storing a program causing a computer to execute a process, the process comprising:
generating intermediate data by analyzing print data, the intermediate data being data in a stage preceding raster data that is a group of pixels;
converting the generated intermediate data into the raster data;
calculating an expected processing time, the expected processing time being an expected time to be spent on converting a predetermined amount of generated intermediate data into raster data; and
selecting, as a printing speed of a print mechanism unit, any one of a plurality of predetermined speeds by using the calculated expected processing time.
